(19) United States
(12) Patent Application Publication
(10) Pub. No.: US 2005/0200764 A1
(43) Pub. Date: Sep. 15, 2005

(54) Encoded video data synthesis apparatus

(75) Inventors: Toru Tsuruta, Kawasaki (JP); Takashi Hamano, Kawasaki (JP); Ryuta Tanaka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/981,629

(22) Filed: Nov. 5, 2004

(30) Foreign Application Priority Data
Feb. 27, 2004 (JP) 2004-055378

(51) Int. Cl. H04N 5/91

(52) U.S. Cl. 348/716

(57) ABSTRACT

An encoded video data synthesis apparatus includes: a decoding unit having N, that is, two or more, decoders for decoding input encoded video data; an encoding unit having N encoders for encoding image data from the decoding unit; a buffer unit having N buffers which can store the encoded video data as a process result of the encoding unit for a predetermined number of frames; a stream synthesis unit for performing a synthesizing process on the encoded video data of one frame from each buffer; and a control unit for issuing an instruction to perform a synthesizing process to the stream synthesis unit. The encoded video data synthesis apparatus can further include a frame memory unit having N frame memory which can store a predetermined number of pieces of image data from a decoding unit between a decoding unit and an encoding unit.

### BACKGROUND OF THE INVENTION

1. Field of the Invention

The present invention relates to an encoded video data synthesis apparatus.

2. Description of the Related Art

A multipoint control unit (hereinafter referred to as an MCU) receives encoded video data transmitted from TV conference terminals mounted on a plurality of points, and transmits to each of the TV conference terminals, for example, the encoded video data of other terminals except the encoded video data transmitted by each of the terminals.

In the above-mentioned TV conference system having a plurality of TV conference terminals and the MCU connected to the terminals, various systems have been realized. In the explanation given by referring to FIGS. 1 through 6, when a conference is held using TV conference terminals mounted at 5 points, composite images are transmitted to each point from the other four points.

First, FIG. 1 shows the configuration of the MCU for performing the image synthesizing process based on the stream multiplex method.

In the stream multiplex system, header detection units 101₁, . . . , 101₄ in the MCU receive encoded video data transmitted from the TV conference terminals mounted on the plurality of points (four points in this example) The header detection units detect the frame header inserted into each frame in the encoded video data, insert the point number for identification of each point into the detected frame header, and temporarily store the number in the buffer 102₁, . . . , 102₄. A buffer monitor unit 104 monitors the storage status of the data in the buffers. For example, when data are presented for all buffers, it issues an instruction to a control unit 105 to activate a multiplexing unit 103. The multiplexing unit 103 is activated at the instruction from the control unit 105, reads the encoded video data, in which a point number is inserted into the above-mentioned header unit, for each frame from the buffers 102₁, . . . , 102₄, multiplexes the data, and transmits the data to each TV conference terminal. The above-mentioned stream multiplex system is disclosed by, for example, the following patent literature 1.

FIG. 2 shows the configuration of the MCU of the stream multiplex system available at five points. As shown in FIG. 2, this stream multiplex system can cope with the addition of a point by only mounting (adding) a multiplexing unit.

FIG. 3 shows the configuration of the MCU for performing the image synthesizing process in the stream synthesis system.

In the stream synthesis system, buffers 111₁, . . . , 111₄ receive encoded video data transmitted from the TV conference terminals mounted at a plurality of points (four points in this example) and temporarily store the data. A buffer monitor unit 113 monitors the storage status of the data in the buffer. When data are presented for all buffers, it issues to a control unit 114 an instruction to activate a stream synthesizing unit 112. At the instruction from the control unit 114, the stream synthesizing unit 112 is activated, and performs the synthesizing process on the encoded video data as is. At this time, data is renumbered such that data can be assigned a serial number at the boundary of the encoded video data in such way that a receiving TV conference terminal can recognize composed encoded video data as a piece of encoded video data. The above-mentioned stream synthesis system is disclosed by, for example, the following patent literature 2.

The patent literature 2 also discloses the device for avoiding the transmission delay of the encoded video data from the MCU. That is, the encoded video data is not transmitted after one frame of data is obtained for all points. That is, data can be transmitted from the MCU when there is any point at which one frame of data is not obtained. Therefore, the information (GOB 0) indicating that no change is made to the previous image data is inserted into the point where one frame of data is not obtained.

FIG. 4 shows the configuration of the MCU in the stream synthesis system available for five points. As shown in FIG. 4, this stream synthesis system can cope with the addition of a point by only adding a stream synthesis unit.

FIG. 5 shows the configuration of the MCU for performing the image synthesizing process based on the complete synthesis system. In this complete synthesis system, decoders 121₁, . . . , 121₄ in the MCU receive the encoded video data transmitted from the TV conference terminal mounted at a plurality of points (four points in this example), performs the decoding process on the data from each point, and accumulates the image in frame memory 122₁, . . . , 122₄. Then, through image size changing processes 123₁, . . . , 123₄, the image size changing process such as enlarging, reducing, etc. is performed on the images accumulated in the frame memory. A memory management unit 127 manages the storage status of the data in the frame memory. Then, for example, when data are prepared for all frame memory, an instruction to read data from the frame memory, and activate a series of processes including the image size changing process, the screen synthesizing process, and the encoding process is issued to a control unit 128. A screen synthesizing unit 125 inputs size-changed image data by the image size changing process, and performs the process of synthesizing images of a point, for example, of other terminals excluding the image transmitted by the terminal of the point as one screen. An encoder 126 performs the encoding process for the synthesized one screen. The encoded data is transmitted to a terminal at a predetermined point. The complete synthesis system is disclosed by, for example, the following patent literature 3.

FIG. 6 shows the configuration of the MCU of the complete synthesis system available at five points. As shown in FIG. 6, in the complete synthesis system, a screen synthesizing unit and an encoding unit are to be added each time a point is added.
[patent literature 1] Japanese Patent Application Laid-open No. Hei 5-37929
   “Video Signal Synthesis System”
[patent literature 2] Japanese Patent Application Laid-open No. Hei 7-222131
   “Multipoint Conference Screen Synthesis System and Method”
[patent literature 3] Japanese Patent Application Laid-open No. Hei 8-205115
   “Image Synthesizing and Encoding Apparatus”

In the above-mentioned stream multiplex system, the main process of the MCU is a frame header detecting process, a process of inserting a point number into a header unit, and a multiplexing process, and no encoding/decoding process is performed on the received encoded video data. Therefore, since the encoding process which is the first cause of an increase of the load of the apparatus of the MCU can be omitted, the process load of the apparatus can be reduced.

However, in this system, it is necessary for a TV conference terminal for receiving the encoded video data from the MCU to know on what rules a point number is inserted in the MCU. That is, on the transmission side and the reception side, it is necessary to settle a rule relating to the items other than the standards fixed among the upper layers. This can also be described as “not capable of decoding data as one piece of encoded video data”. As clearly described above, the decoding process is performed without depending on the standard procedure on the reception side in this system. That is, the received encoded video data is treated in the decoding process by point.

In the above-mentioned stream synthesis system, numbers are reassigned for allocating serial numbers on the boundary of the encoded video data to be transmitted to other points. Therefore, the encoding/decoding process is not performed, thereby reducing the load of an apparatus on the MCU side. as in the above-mentioned stream multiplex system.

For example, when the motion compensation inter-frame coding system of H.261 which is the standard encoding system for the TV phone and TV conference is applied, the reference screen available for prediction is restricted in the same screen. Therefore, the motion vector does not point to outside the screen, and the stream synthesis system can be applied without problem. However, in the MPEG system, etc., the motion vector pointing to outside the screen exists, and a process different from a vector pointing to inside the screen is prescribed. For example, assume that a vector pointing to outside exist on the portion of the frame of the screen before the synthesis performed, and the portion is combined with the screen position adjacent to the screen of another point after the synthesis. Originally, the vector pointing to outside the screen is treated in a process different from the process performed on the vector pointing to inside the screen. However, after the synthesis, the vector can be processed as a vector pointing to inside the screen. In this case, the same reference screen as in the encoding process cannot be generated, and the screen treated by the decoding process is degraded.

Therefore, to avoid the disadvantage during decoding, it is necessary in the MPEG system to place restrictions on the encoding system not to generate a motion vector pointing to outside the screen during encoding. That is, the MCU can not be connected to all of a TV conference terminal in the encoding system in accordance with the standards.

In the above-mentioned complete synthesis system, in the MCU, the decoding process is performed on the encoded video data from a plurality of receiving points, and the screen synthesizing process for synthesizing the decoded image data is performed depending on the destination TV conference terminal. Before transmitting the synthesized screen data to a TV conference terminal, the process of encoding the synthesized image data is performed for each of the destination points. Therefore, for the motion vector, it is not necessary to place restrictions, for example, to constantly point to inside the screen, as in the stream synthesis system. However, in the MCU, as compared with the technology described in the patent literature 1 and 2, in which the encoding/decoding process is not performed, there is the problem that the load of the apparatus on the MCU side greatly increases. Additionally, as shown in FIG. 6, when a point is added in this system, an encoding unit having a heavy process load is mounted each time it is added. This means a sudden increase of process load with an increasing number of points.

### SUMMARY OF THE INVENTION

The present invention aims at providing a encoded video data synthesis apparatus capable of transmitting encoded video data, which includes image data at a plurality of points, and can be decoded as a piece of encoded video data, to a receiving terminal without setting a heavy load of an apparatus.

The encoded video data synthesis apparatus according to the present invention includes: a decoding unit having N, that is, two or more, decoders for decoding input encoded video data; an encoding unit having N encoders for encoding image data from a decoding unit; a buffer unit having N buffers which can store a predetermined number of frames of the encoded video data of the processing result of the encoding unit; a stream synthesis unit for performing a synthesizing process on the encoded video data of one frame from each buffer; and a control unit for issuing an instruction to perform a synthesizing process to the stream synthesis unit. The encoded video data synthesis apparatus according to the present invention can further include a frame memory unit having N frame memory which can store a predetermined number of pieces of image data from a decoding unit between a decoding unit and an encoding unit.

### BRIEF DESCRIPTION OF THE DRAWINGS

FIG. 1 shows the configuration of the MCU for performing the image synthesizing process based on the stream multiplex system;

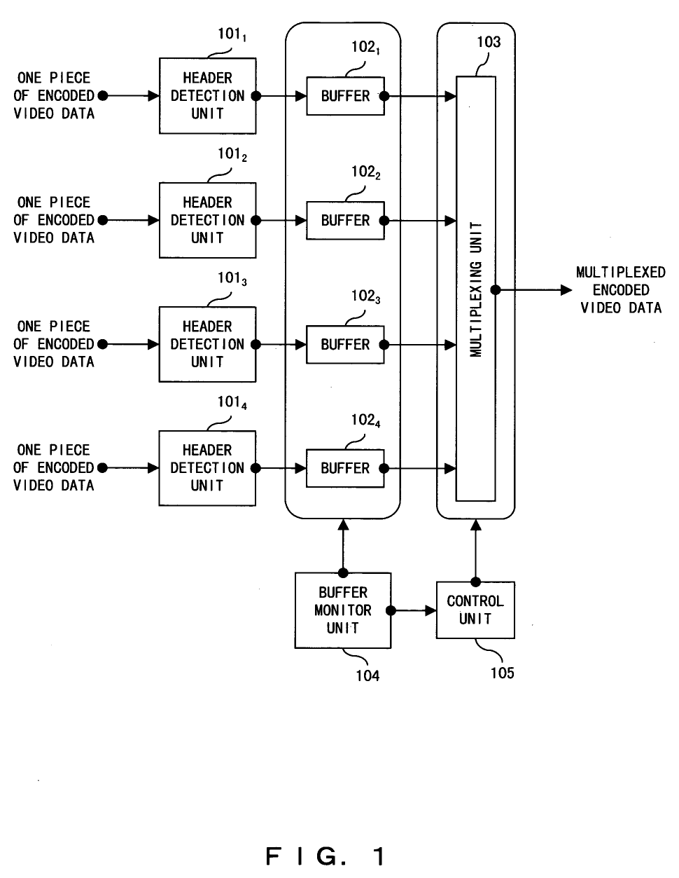

FIG. 2 shows the configuration of the MCU of the stream multiplex system available for five points;

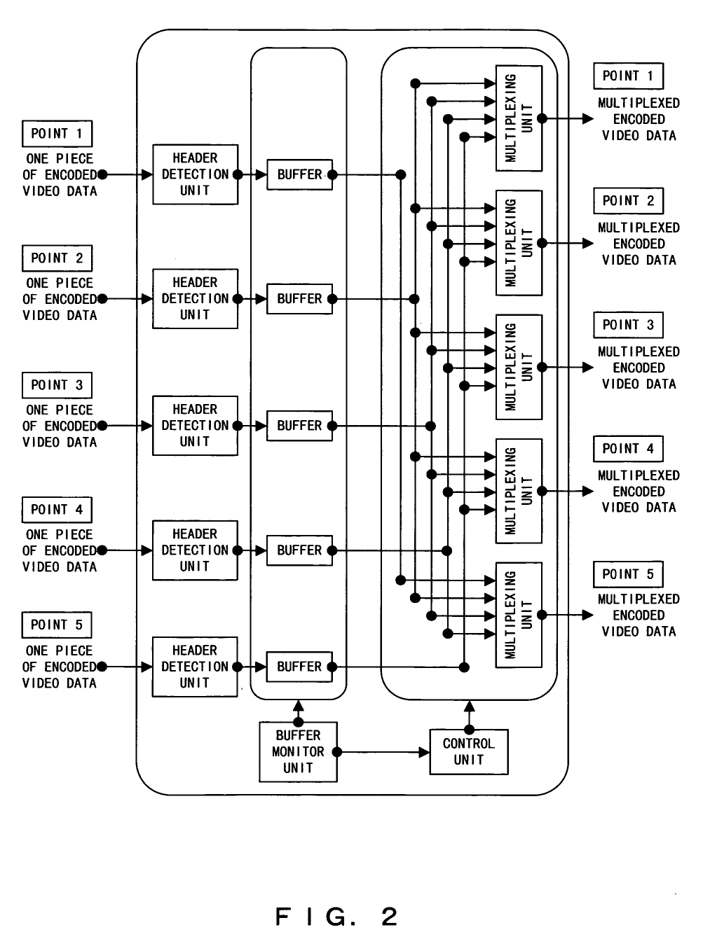

FIG. 3 shows the configuration of the MCU for performing the image synthesizing process based on the stream synthesis system;

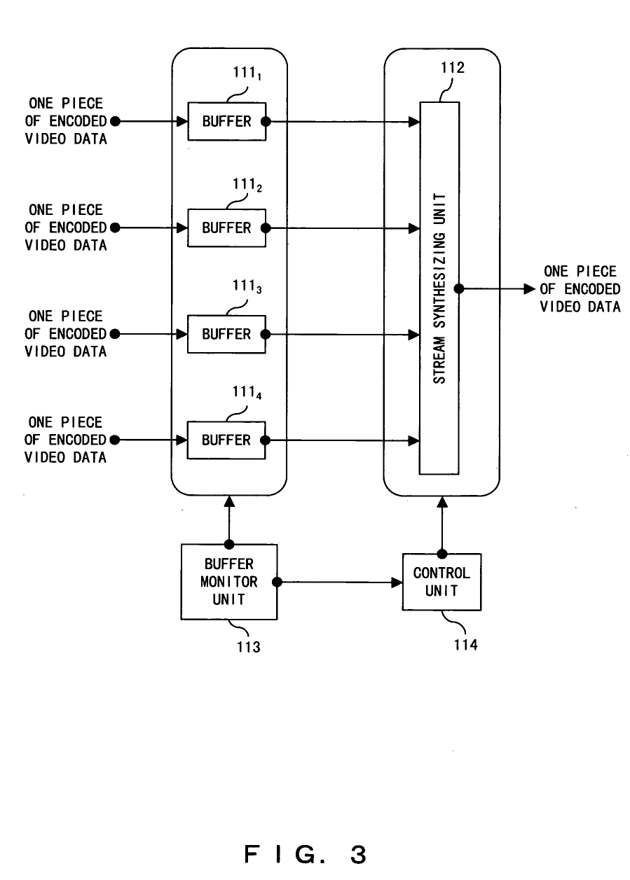

FIG. 4 shows the configuration of the MCU of the stream synthesis system available for five points;

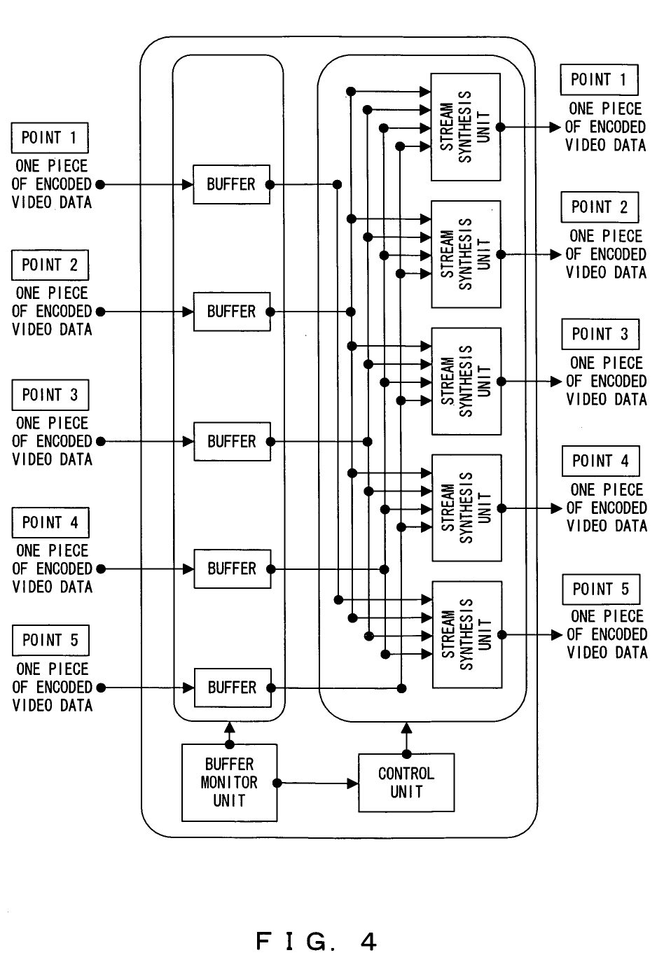

FIG. 5 shows the configuration of the MCU for performing the image synthesizing process based on the complete synthesis system;

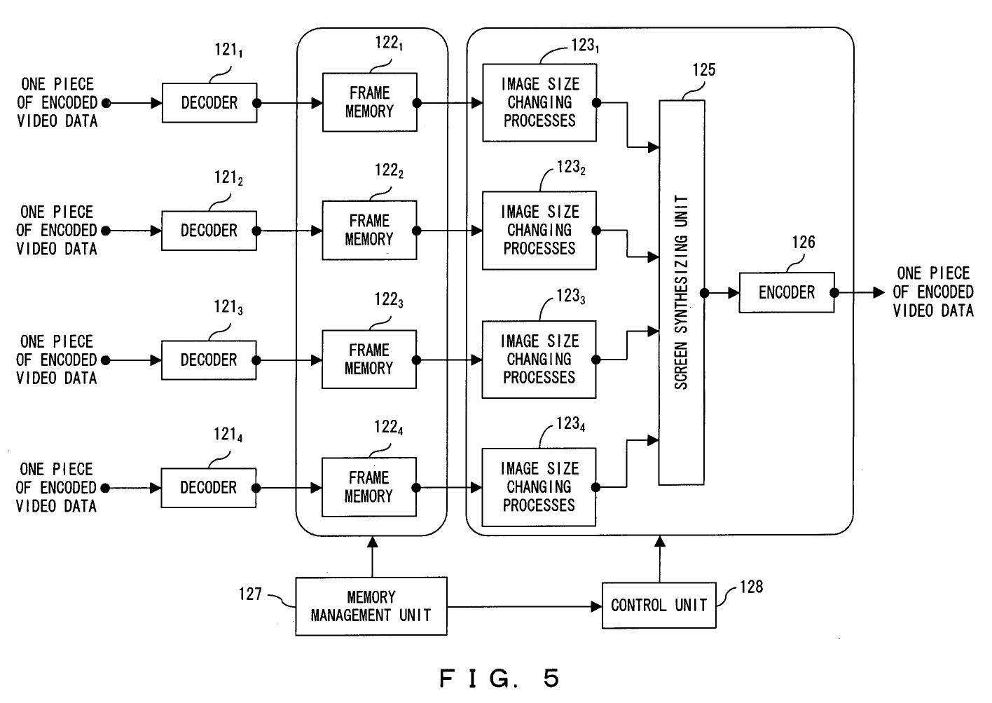

FIG. 6 shows the configuration of the MCU of the complete synthesis system available for five points;

FIG. 7 is a block diagram of the configuration of the encoded video data synthesis apparatus according to the first aspect of the present invention;

FIG. 8 is a block diagram of the configuration of the encoded video data synthesis apparatus according to the second aspect of the present invention;

FIG. 9 is a block diagram of the configuration of the encoded video data synthesis apparatus according to the third aspect of the present invention;

FIG. 10 is a block diagram of the configuration of the encoded video data synthesis apparatus according to the fourth aspect of the present invention;

FIG. 11 shows the configuration of the TV conference system common to each embodiment of the present invention;

FIG. 12 is a block diagram of the configuration of the encoded video data synthesis apparatus according to the first embodiment of the present invention;

FIG. 13 shows an example of a transition of the operation of the buffer management table corresponding to the buffer in the buffer unit;

FIG. 14 is a flowchart of the process performed by the control unit;

FIG. 15 shows an example of the stream synthesizing process in step S109 shown in FIG. 14 by referring to a specific format of the encoded video data;

FIG. 16 is a flowchart of the process corresponding to FIG. 15;

FIG. 17 shows the configuration of the encoded video data synthesis apparatus according to the first embodiment available for five points;

FIG. 18 is a block diagram of the configuration of the encoded video data synthesis apparatus according to the second embodiment of the present invention;

FIG. 19 shows an example of a transition of the operation of the frame memory management table corresponding to the frame memory in the frame memory unit;

FIG. 20 is a flowchart (first half) of the process performed by the control unit;

FIG. 21 is a flowchart (second half) of the process performed by the control unit; and

FIG. 22 shows the configuration of the encoded video data synthesis apparatus according to the second embodiment available for five points.

### DESCRIPTION OF THE PREFERRED EMBODIMENTS

The preferred embodiments of the present invention are described below in detail by referring to the attached drawings.

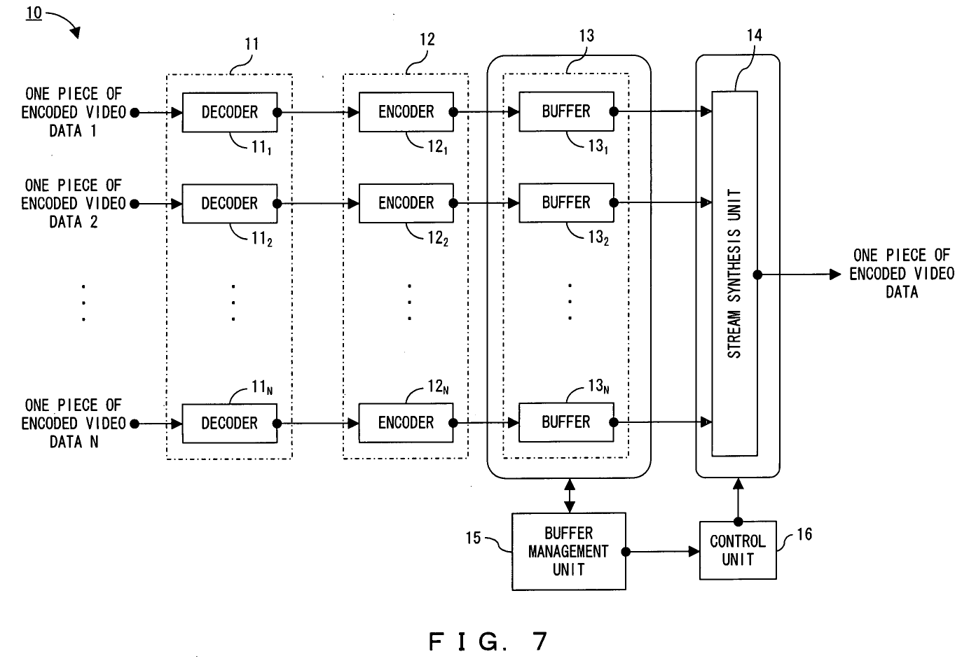

FIG. 7 is a block diagram showing the configuration of the encoded video data synthesis apparatus according to the first aspect of the present invention.

In FIG. 7, an encoded video data synthesis apparatus 10 comprises: a decoding unit 11 having N (two or more) decoders 11₁, 11₂ . . . , 11_{N} for decoding encoded video data inputted; an encoding unit 12 having N encoders 12₁, 12₂ . . . , 12_{N} for encoding the image data from the decoding unit 11; a buffer unit 13 having N buffers 13₁, 13₂ . . . , 13_{N} capable of storing a predetermined number of frames of encoded video data as a processing result of the encoding unit 12; a buffer management unit 15 for managing a buffer management table showing the storage status of the encoded video data in the buffer unit 13; a stream synthesis unit 14 for performing a synthesizing process on the encoded video data of one frame from each buffer; and a control unit 16 for issuing an instruction to the stream synthesis unit 14 to perform the synthesizing process on the one frame of data based on the buffer management table.

In the encoded video data synthesis apparatus according to the first aspect of the present invention, N pieces of input encoded video data are decoded, and then encoded by the encoding unit 12 such that the encoded video data as a processing result can be synthesized as is in the stream synthesis unit 14, and the encoded video data is stored in each buffer. With the timing of reading data, for example, encoded video data of one frame is presented for all buffers, the encoded video data is read from each buffer, and the stream synthesis is performed on the encoded video data.

Thus, as compared with the conventional system in which the decoded image data is synthesized for the TV conference terminal at each point, and the synthesized screen data is encoded, the amount of image data to be encoded can be considerably reduced. Additionally, the encoded video data transmitted to the TV conference terminal at each point is not treated in a specific operation such as inserting a point number, etc. into a header unit, and since it is not necessary to fix an item other than those fixed by standards, the data can be decoded as one piece of encoded video data.

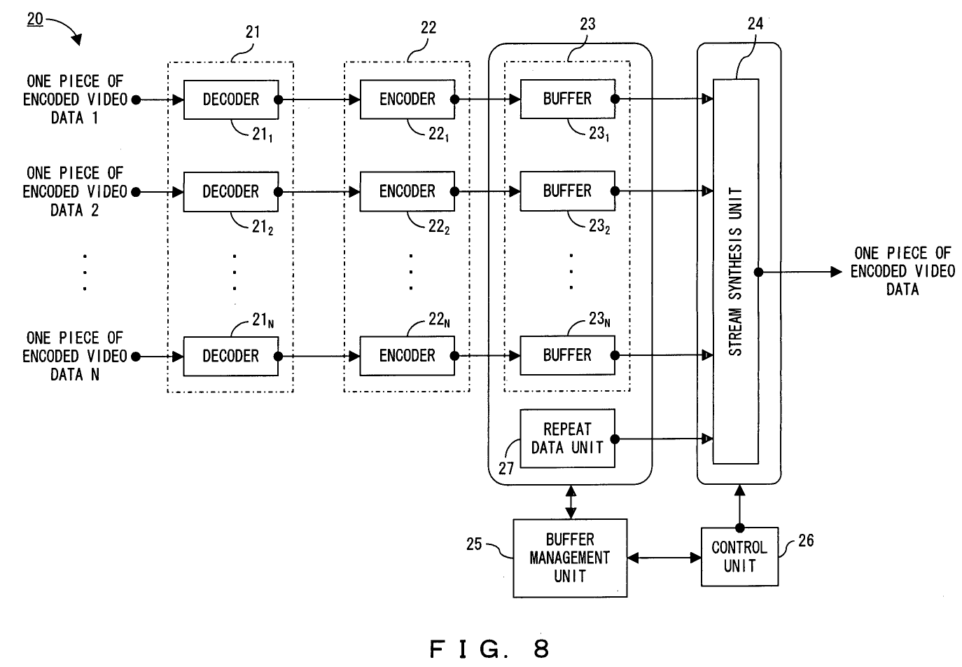

FIG. 8 is a block diagram showing the configuration of the encoded video data synthesis apparatus according to the second aspect of the present invention.

In FIG. 8, an encoded video data synthesis apparatus 20 comprises: a decoding unit 21 having N (two or more) decoders 21₁, 21₂ . . . , 21_{N} for decoding encoded video data inputted; an encoding unit 22 having N encoders 22₁, 22₂ . . . , 22_{N} for encoding the image data from the decoding unit 21; a buffer unit 23 having N buffers 23₁, 23₂ . . . , 23_{N} capable of storing a predetermined number of frames of encoded video data as a processing result of the encoding unit 22; a buffer management unit 25 for managing a buffer management table showing the storage status of the encoded video data in the buffer unit 23; a stream synthesis unit 24 for performing a synthesizing process on the encoded video data of one frame from each buffer; a control unit 26 for issuing an instruction to the stream synthesis unit 24 to perform the synthesizing process on the one frame of data based on the buffer management table; and a repeat data unit 27 for holding repeat data indicating that the error from the previous data is zero.

In the above-mentioned second aspect, the repeat data unit 27 is added to the first aspect of the present invention. In at least one buffer in the buffer unit 23, when there is no encoded video data, the control unit 26 uses the repeat data of the repeat data unit 27 as the encoded video data for the buffer having no encoded video data.

Thus, the stream synthesis can be performed without waiting for the encoded video data of one frame to present for all buffers. Therefore, the transmission delay of the encoded video data from the encoded video data synthesis apparatus can be avoided.

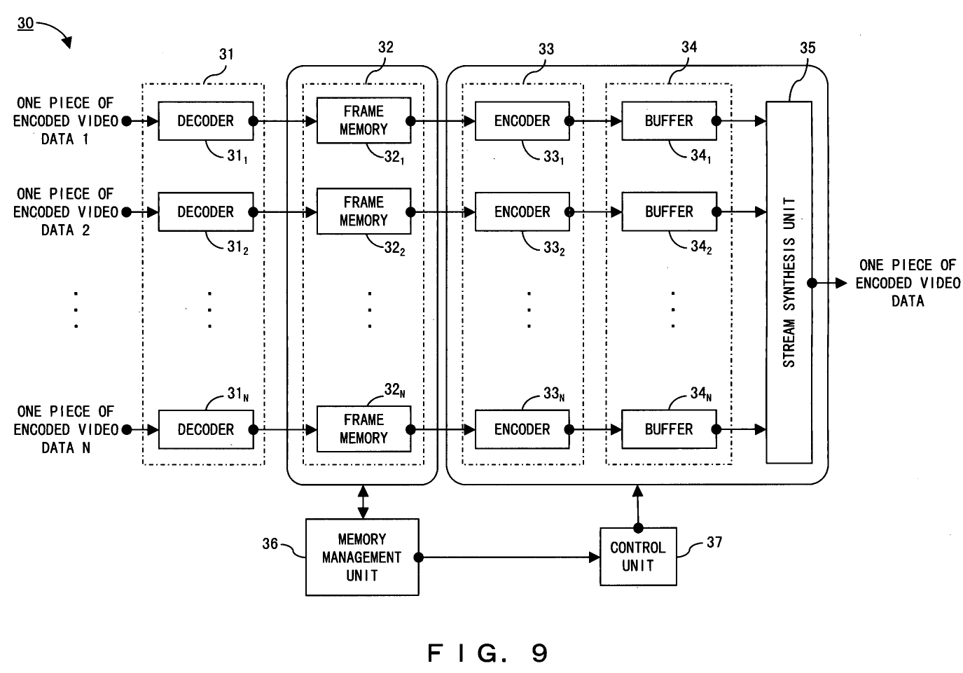

FIG. 9 is a block diagram showing the configuration of the encoded video data synthesis apparatus according to the third aspect of the present invention.

In FIG. 9, an encoded video data synthesis apparatus 30 comprises: a decoding unit 31 having N (two or more) decoders 31₁, 31₂ . . . , 31_{N} for decoding encoded video data inputted; a frame memory unit 32 having N frame memory 32₁, 32₂ . . . , 32_{N} capable of storing a predetermined number of frames of image data from the decoding unit 31; a memory management unit 36 for managing the frame memory management table indicating the storage status of the image data in the frame memory unit 32; an encoding unit 33 having N encoders 33₁, 33₂ . . . , 33_{N} for encoding the image data from the frame memory unit 32; a buffer unit 34 having N buffers 34₁, 34₂ . . . , 34_{N} capable of storing at least one frame of encoded video data as a processing result of the encoding unit 33; a stream synthesis unit 35 for performing the synthesizing process on the encoded video data of one frame from each buffer; and a control unit 37 for controlling the encoding unit 33 and the buffer unit 34 based on the frame memory management table, and issuing an instruction to the stream synthesis unit 35 to perform the synthesizing process on the one frame of data.

In the encoded video data synthesis apparatus according to the third aspect of the present invention, N pieces of input encoded video data are decoded, and then the data is temporarily stored in the frame memory unit 32. Therefore, the encoding unit 33 can synchronously encode the image data. Thus, image data of different formats such as the “I picture” processed by encoding one frame of data only by intra-frame coding, and the “P picture” processed by encoding one frame of data using interframe difference data from the past frame in addition to the intra-frame coding can be treated. With the timing of reading data, for example, image data of one frame is presented for all frame memory, image data is read from each frame memory, and the encoding unit 33 encodes the image data such that the encoded video data as a processing result can be synthesized as is in the stream synthesis unit 35 at the later stage, and the stream synthesis is performed by the stream synthesis unit 35 via the buffer unit 34.

Thus, as compared with the conventional system in which the decoded image data is synthesized for the TV conference terminal at each point, and the synthesized screen data is encoded, the amount of image data to be encoded can be considerably reduced. Additionally, the encoded video data transmitted to the TV conference terminal at each point is not treated in a specific operation such as inserting a point number, etc. into a header unit, and since it is not necessary to fix an item other than those fixed by standards, the data can be decoded as one piece of encoded video data.

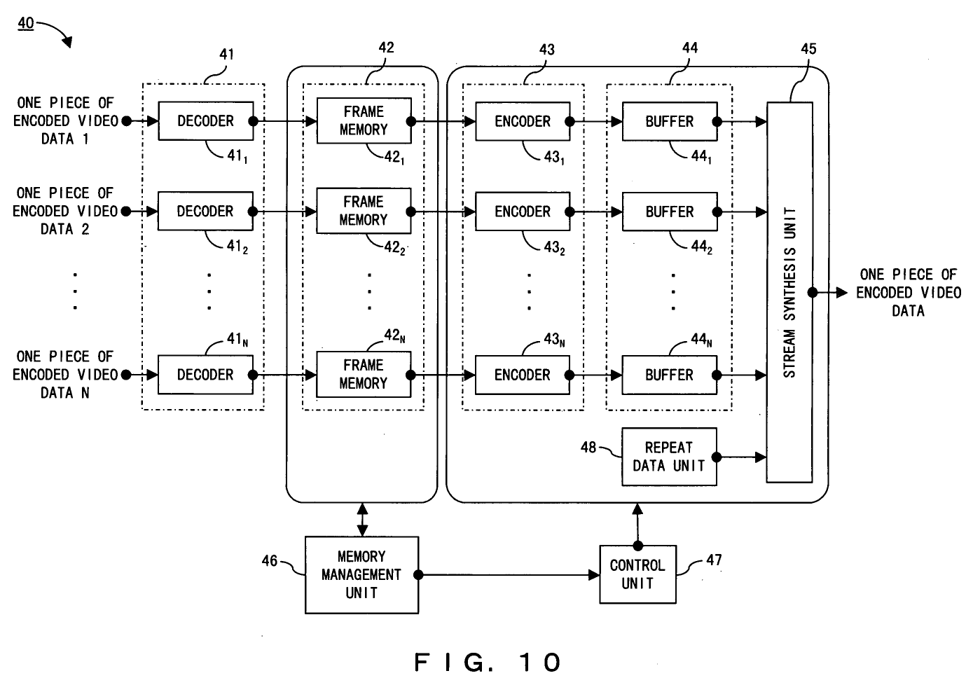

FIG. 10 is a block diagram showing the configuration of the encoded video data synthesis apparatus according to the fourth aspect of the present invention.

In FIG. 10, the encoded video data synthesis apparatus comprises: a decoding unit 41 having N (two or more) decoders 41₁, 41₂ . . . , 41_{N} for decoding encoded video data inputted; a frame memory unit 42 having N frame memory 42₁, 42₂ . . . , 42_{N} capable of storing a predetermined number of frames of image data from the decoding unit 41; a memory management unit 46 for managing the frame memory management table indicating the storage status of the image data in the frame memory unit 42; an encoding unit 43 having N encoders 43₁, 43₂ . . . , 43_{N} for encoding the image data from the frame memory unit 42; a buffer unit 44 having N buffers 44₁, 44₂ . . . , 44_{N} capable of storing at least one frame of encoded video data as a processing result of the encoding unit 43; a stream synthesis unit 45 for performing the synthesizing process on the encoded video data of one frame from each buffer; a control unit 47 for controlling the encoding unit 43 and the buffer unit 44 based on the frame memory management table, and issuing an instruction to the stream synthesis unit 45 to perform the synthesizing process on the one frame of data; and a repeat data unit 48 for holding repeat data indicating that the error from the previous data is zero.

In the fourth aspect of the present invention, the control unit 47 comprises an encoding format determination unit for determining the encoding by the encoder as the “I picture” processed by encoding one frame of data only by intra-frame coding, or the “P picture” processed by encoding one frame of data using interframe difference data from the past frame in addition to the intra-frame coding, and issues an instruction to each of the encoders to encode each piece of image data from the frame memory unit 42 based on the determined encoding format.

When encoding data as a P picture, and when there is no new image data at least one unit of frame memory in the frame memory unit 42, the control unit 47 cannot allow the corresponding encoder to perform a process on the frame memory having no new image data, and since there is no encoded video data in the corresponding buffer, the repeat data of the repeat data unit 48 is used as the data for the buffer having no encoded video data.

With the above-mentioned configuration and operation, the control unit can activate a series of processes from reading data from the frame memory unit to stream synthesis without waiting for the preparation of image data of one frame for all frame memory. Therefore, the transmission delay of the encoded video data from the encoded video data synthesis apparatus can be avoided.

The encoded video data synthesis apparatus according to the present invention decodes N pieces of encoded video data inputted, and then preferably, for example, encodes the image data such that the encoded video data can be synthesized as is by the stream synthesis unit at the later stage. The encoded video data is stored in each buffer. With the timing of reading data, for example, one frame of encoded video data is presented for all buffers, encoded video data is read from each buffer, and the stream synthesis is performed on the encoded video data.

Thus, as compared with the conventional system in which the decoded image data is synthesized for the TV conference terminal at each point, and the synthesized screen data is encoded, the amount of image data to be encoded can be considerably reduced. Additionally, the encoded video data transmitted to the TV conference terminal at each point is not treated in a specific operation such as inserting a point number, etc. into a header unit, and since it is not necessary to fix an item other than those fixed by standards, the data can be decoded as one piece of encoded video data.

In the encoded video data synthesis apparatus according to the present invention, N pieces of encoded video data inputted are decoded, and then the data is temporarily stored in the frame memory unit. Therefore, the encoding unit can synchronously encode the image data. Thus, image data of different formats such as the “I picture”, the “P picture”, etc. can be treated. With the timing of reading data, for example, image data of one frame is presented for all frame memory, image data is read from each frame memory, and the encoding unit encodes the image data such that the encoded video data of the encoding result can be synthesized as is in the stream synthesis unit at the later stage, and the stream synthesis is performed by the stream synthesis unit via the buffer unit.

Thus, as compared with the conventional system in which the decoded image data is synthesized for the TV conference terminal at each point, and the synthesized screen data is encoded, the amount of image data to be encoded can be considerably reduced. Additionally, the encoded video data transmitted to the TV conference terminal at each point is not treated in a specific operation such as inserting a point number, etc. into a header unit, and since it is not necessary to fix an item other than those fixed by standards, the data can be decoded as one piece of encoded video data.

In the following explanation of the present embodiments, five TV conference terminals are connected to the encoded video data synthesis apparatus to configure a TV conference system. For example, each terminal displays combined data from encoded video data from the other four terminals. It is easy to extend the explanation of each embodiment to a TV conference system configured by M TV conference terminals and the MCU connected to the M TV conference terminals.

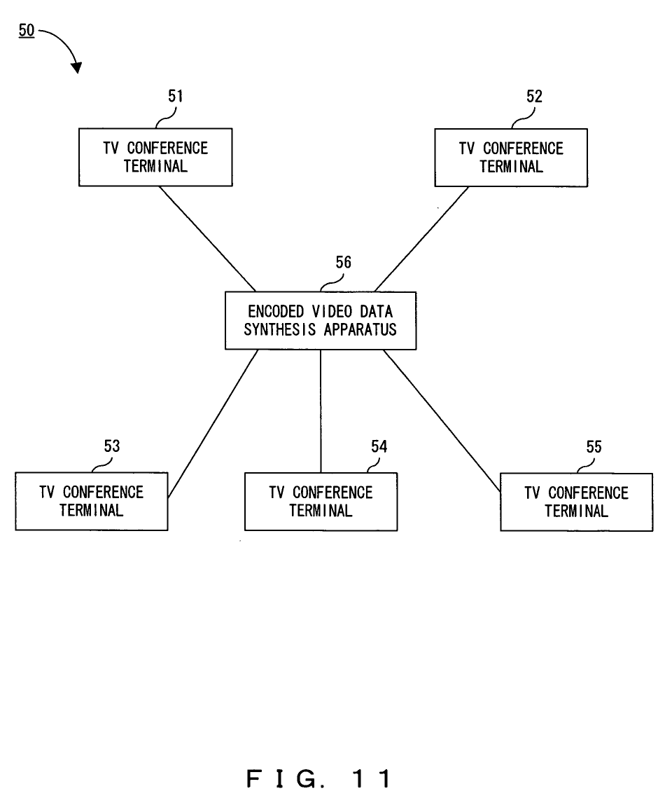

FIG. 11 shows the configuration of the TV conference system common to each embodiment of the present invention.

In FIG. 11, a TV conference system 50 is configured by TV conference terminals 51, 52, 53, 54 and 55 connected to an encoded video data synthesis apparatus 56.

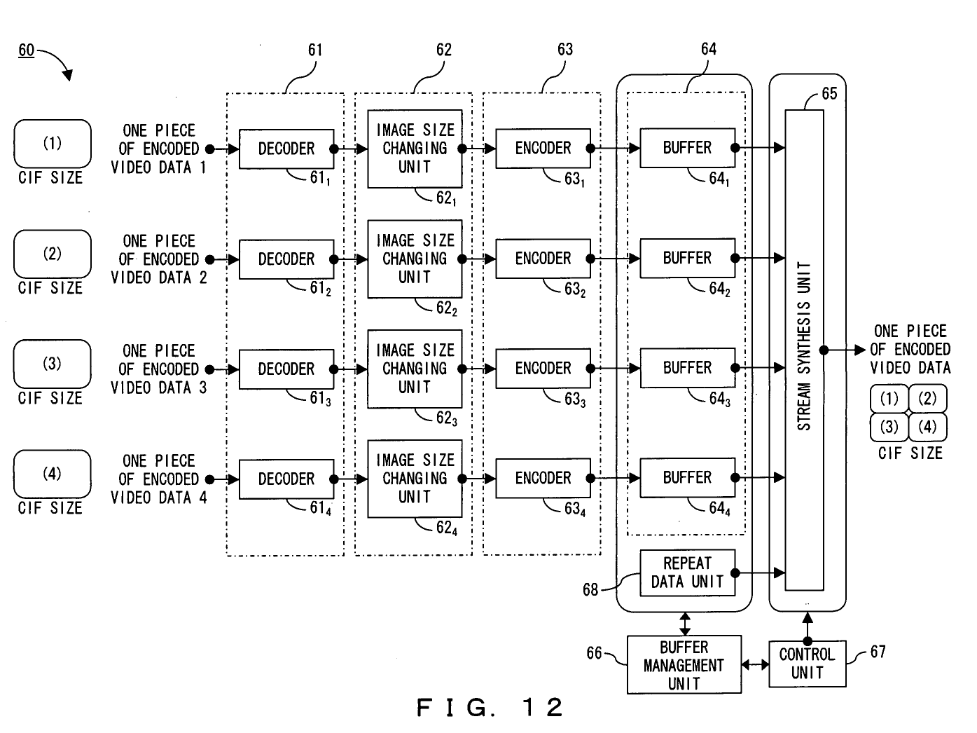

FIG. 12 is a block diagram showing the configuration of the encoded video data synthesis apparatus according to the first embodiment of the present invention. The encoded video data synthesis apparatus shown in FIG. 12 combines the image data from, for example, the TV conference terminals 51, 52, 53, and 54 shown in FIG. 11, and transmits the data to the TV conference terminal 55.

In FIG. 12, an encoded video data synthesis apparatus 60 comprises a decoding unit 61, an image size changing unit 62, an encoding unit 63, a buffer unit 64, a stream synthesis unit 65, a buffer management unit 66, a control unit 67, and a repeat data unit 68.

The decoding unit 61 comprises decoders 61₁, 61₂, 61₃, and 61₄. The image size changing unit 62 comprises size changing processes 62₁, 62₂, 62₃, and 62₄. The encoding unit 63 comprises encoders 63₁, 63₂, 63₃, and 63₄. The buffer unit 64 comprises buffers 64₁, 64₂, 64₃, and 64₄.

In FIG. 12, for example, encoded video data from the TV conference terminals 51 through 54 shown in FIG. 11 are inputted to each of the decoders 61₁, 61₂, 61₃, and 61₄ of the decoding unit 61. Then, the decoding process is performed on the encoded video data, and expanded as necessary.

The image size changing unit 62 performs the image size changing process such as an enlarging process, a reducing process, etc. In the present embodiment, the image size changing unit 62 reduces the image size of the received image data to ¼ of the original size. That is, each of the size changing processes 62₁, 62₂, 62₃, and 62₄ reduces the image size of the image data obtained by the decoding process performed by each of the decoders 61₁, 61₂, 61₃, and 61₄ to ¼ of the original size. When no size change is made to the received image size, the image size changing unit 62 can be excluded from the configuration of the encoded video data synthesis apparatus.

For example, when each TV conference terminal encodes and transmits an image of a CIF (common intermediate format: 352 pixels wide×288 pixels long), the encoded video data is decoded to the image of the CIF size through each decoder, and the decoded image data is treated in each size changing process, reduced to ¼ in size, that is, a QCIF (176 pixels wide×144 pixels) size.

Then, the ¼ reduced image data is input to the encoding unit 63. Then, after compression of the image data as necessary, the encoding unit 63 performs an encoding process to the reduced image data such that the encoded video data of the encoding result can be synthesize as is in the stream synthesis unit 65.

That is, through each of the size changing processes 62₁, 62₂, 62₃, and 62₄, the ¼ reduced image data is input to each of the encoders 63₁, 63₂, 63₃, and 63₄, and then the encoding process which makes stream synthesis at the later stage easier, for example, in the MPEG 4 system, not to allow a vector to point to outside the screen, is performed.

Each of the buffers 64₁, 64₂, 64₃, and 64₄ stores encoded video data as a process result through the encoders 63₁, 63₂, 63₃, and 63₄.

The buffer management unit manages the buffer management table indicating the storage status of the encoded video data in the buffers 64₁, 64₂, 64₃, and 64₄. The buffer management table is rewritten corresponding to the input of the image data from the encoders 631, 632, 633, and 634 in the previous stage and a write instruction from the control unit.

With the configuration shown in FIG. 12, according to the first embodiment, the encoding process by the encoding unit 63 is asynchronously performed. Therefore, the encoded video data synthesis apparatus according to the first embodiment processes only one type of image data, for example, only the I picture, or only the P picture. The I picture is configured by only the intra-frame coding in one frame. The P picture is configured based on the difference data from the reference frame of another transmitted frame in addition to the intra-frame coding. Therefore, an image cannot be correctly regenerated only by the encoded data of the P picture.

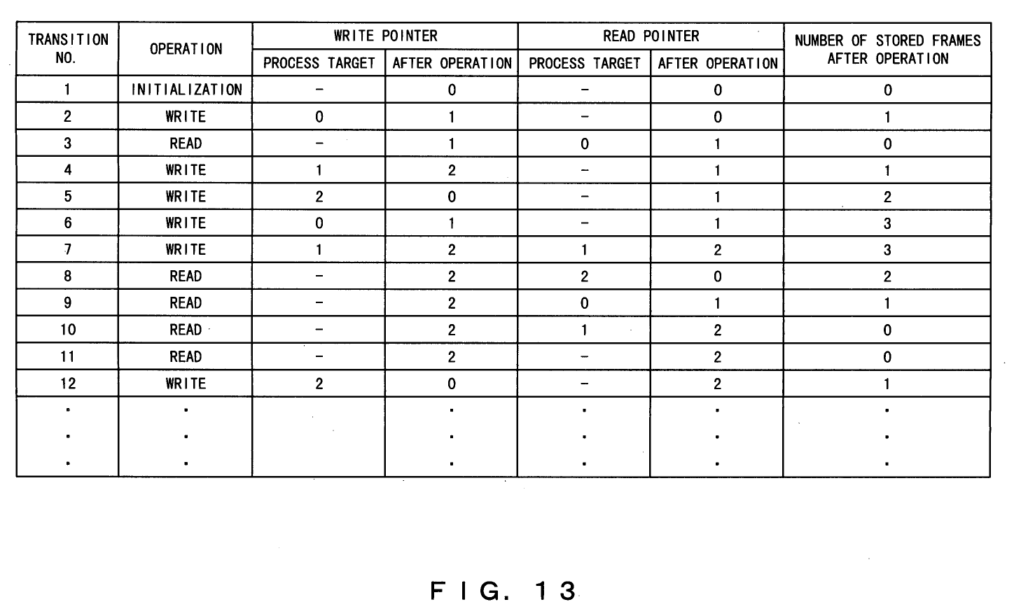

FIG. 13 shows an example of the update status in a time series of the buffer management table corresponding to the buffer in the buffer unit 64, that is, a transition of an operation.

In FIG. 13, the buffer management table corresponding to the buffer is configured by a ring buffer having the maximum number 3 of stored frames. Therefore, the write pointer indicating the start of the write area of data and the read pointer indicating the start of the read area of data are set to any of the values “0”, “1”, or “2”.

In the example shown in FIG. 13, initialization is carried out first in the transition No. 1, and the write pointer and the read pointer are set to 0. In the transition No. 2, when the encoded video data from the encoder at the previous stage is input to the buffer, the encoded video data is written to the area of the number “0”. After the writing operation, the write pointer as the pointer pointing to the start of the area to which data is next written is incremented to “1”. The number of storage frame indicating the number of pieces of data currently stored in the buffer is also incremented from “0” to “1”.

Then, in the transition No. 3, at a read instruction from the control unit, the encoded video data stored in the buffer is read. The data is sequentially read from the oldest data. In this reading process, the read pointer as the pointer pointing to the start of the area from which data is next read is incremented from “0” to “1”. The number of stored frames is decremented from “1” to “0”.

Then, in the transition No. 4 through 6, data is written to the buffer from the encoder at the previous stage.

In the series of writing process, the write pointer after the operation is incremented in the order of “1”→“2”→“0”→“1” (since the maximum number of stored frames of “3” is ring buffer, “2” is followed by “0”), and the number of stored frames is synchronously incremented in the order of “0”→“1”→“2”→“3”.

In the status after the operation of the transition No. 6, the ring buffer has already stored the data corresponding to the maximum number of stored frames of 3, and is full. In this status, for example, as shown in the transition No. 7, when a write is continuously performed, the data of the written area of “1” in which the write was performed in the transition No. 4 is overwritten without a read. Therefore, before and after the writing operation of the transition No. 7, the number of stored frames is not changed, but the read pointer is incremented from “1” to “2”.

Then, in the transition No. 8 through 10, at a read instruction from the control unit, the data is read from the buffer.

In the series of reading processes, the read pointer after the operation is sequentially incremented in the order of “2”→“0”→“1”→“2”, and the number of stored frames is synchronously decremented in the order of “3”→“2”→“1”→“0”.

In the transition No. 11, in the status of the number of stored frames of “0”, the control unit issues a read instruction. For the read instruction issued when the number of stored frames is “0”, repeat data of a repeat data unit is used as the data for a buffer having no new encoded video data.

In the transition No. 12, the encoded video data from the encoder at the previous stage is input to the buffer. Then, after the writing operation, the write pointer is incremented from “2” to “0”, and the number of stored frames is incremented from “0” to “1”.

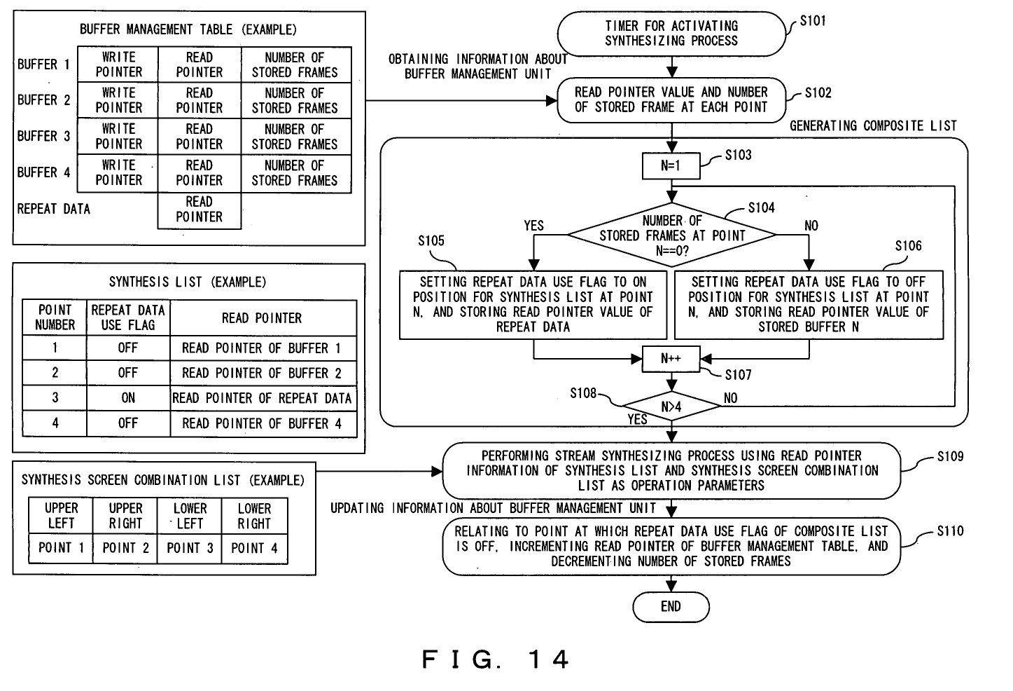

FIG. 14 is a flowchart of the process performed by the control unit. The control unit is activated by the timer set for predetermined intervals, and each time it is activated, the process of the following flowchart is performed.

In FIG. 14, in step S101, a series of processes performed by the control unit is started.

In step S102, by referring to the buffer management table for management of the data corresponding to each buffer as shown in FIG. 14, the read pointer value of each buffer and the number of stored frames are obtained.

Then, using the obtained data, a synthesis list generating process is performed in steps S103 through S109.

First, in step S103, the counter N indicating the number of the buffer is initialized to 1. The counter N indicates the number of the buffer. The buffer stores the encoded video data corresponding to any point. In this flowchart, the encoded video data of the point number N is stored in the buffer N.

In the process in step S104, it is determined whether or not the number of stored frames at the point (buffer) N is 0. If the number of stored frames is not 0, the buffer stores the encoded video data of one or more frames. In this case, the encoded video data stored in the buffer is used in the stream synthesis. Therefore, as shown in step S106, the read pointer corresponding to the buffer N in the buffer management table is specified as the read pointer corresponding to the point (buffer) N in the synthesis list. In addition, in step S106, since no repeat data is used, a repeat data use flag is set to the position OFF, thereby passing control to step S107.

On the other hand, when the number of stored frames at the point (buffer) N is 0, the buffer stores no encoded-video data. In this case, since the repeat data in the repeat data unit is used in the stream synthesis. Therefore, in step S105, a read pointer in the repeat data unit is specified as a read pointer corresponding to the point (buffer) N in the synthesis list. In step S105, since repeat data is used, a repeat data use flag is set to the position ON, thereby passing control to step S107.

In step S107, the counter variable N is incremented, and it is determined in step S108 whether or not the value N after the increment is larger than 4 indicating the total number of buffers. By repeating the processes in steps S104, S105, and S106 on all buffers, a synthesis list can be generated.

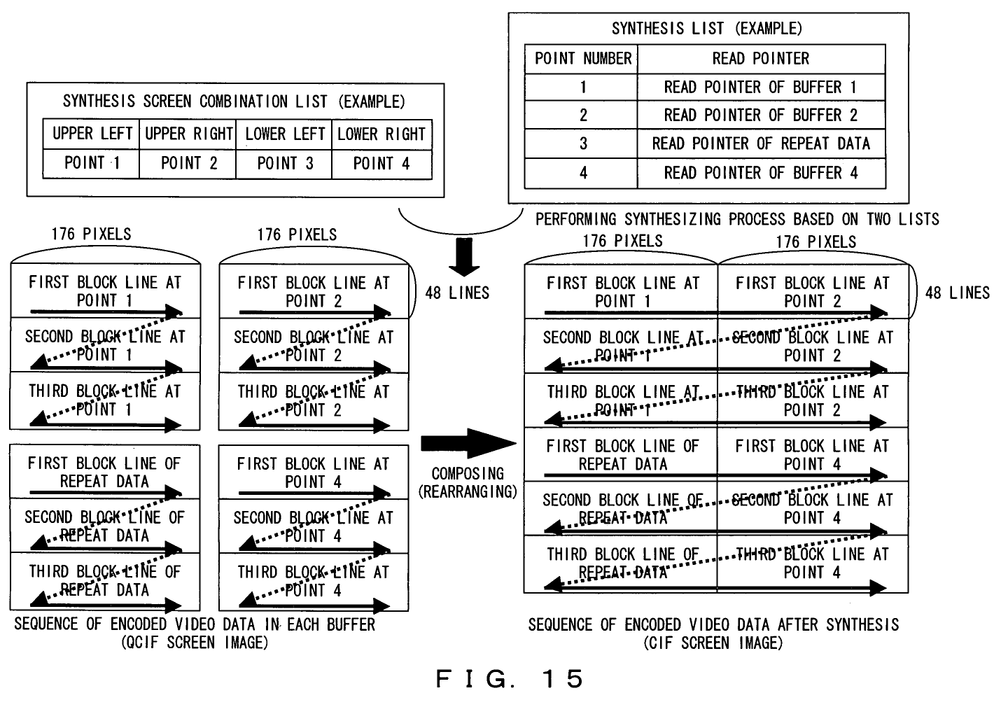

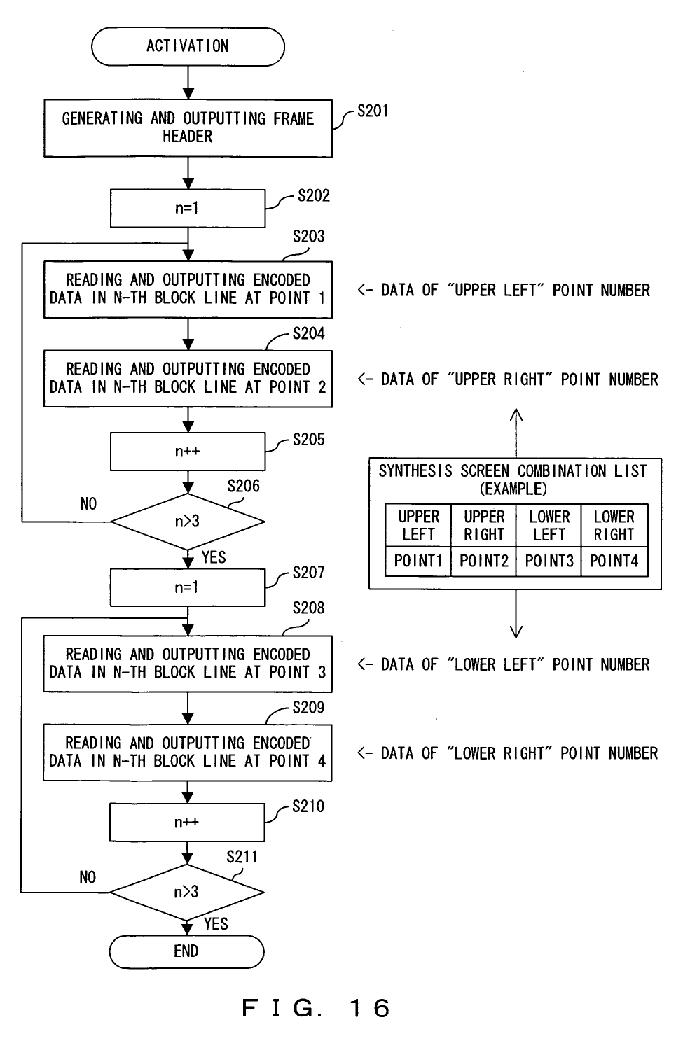

Then, in step S109, the stream synthesizing process is performed based on the synthesis list and the synthesis screen combination list shown in FIG. 14. An example of the stream synthesizing process is shown in FIGS. 15 and 16.

In step S110, relating to the point (buffer) in which the repeat data use flag of the composite list is OFF, the read pointer of the buffer corresponding to the buffer management table is incremented, and the number of stored frames is decremented, thereby updating the information of the buffer management table.

FIG. 15 shows the stream synthesizing process in step S109 shown in FIG. 14 by referring to the specific format of the encoded video data. FIG. 16 is a flowchart of the process corresponding to FIG. 15.

In FIGS. 15 and 16, the raster scanning using the horizontal image size×48 lines as one block line is the format of the encoded video data, but other various encoding formats can be applied.

In FIG. 15, the encoded video data before the synthesis in each buffer is shown in the lower left portion. The screen size of the screen data before the synthesis is QCIF (176 pixels×144 lines), and is configured by 3 block lines using 176 pixels×48 lines as one block line. One piece of screen data is, as indicated by an arrow as shown in FIG. 15, the trailer of the first block line is connected to the header of the second block line, and the trailer of the second block line is connected to the header of the third block line.

In the lower right portion shown in FIG. 15, the screen obtained by combining each screen of the QCIF size in the lower left portion is shown. The screen size of the screen is given y the CIF (352 pixels×288 lines). The four screens of QCIF size shown in the lower left portion can be combined as the screen of CIF size by combining six block lines with each block line defined as 352 pixels×48 lines as shown in FIG. 15.

FIG. 16 is a flowchart of the synthesizing process performed by the stream synthesis unit. The stream synthesis unit activated by the control unit performs the stream synthesizing process based on the synthesis screen combination list and the synthesis list.

In FIG. 16, first in step S201, the frame header generating and outputting process is performed. The image data of one frame is normally provided with the frame header.

In step S202, the counter n is set to 1. By referring to the synthesis screen combination list, the composite data in the upper half of the screen of CIF size is configured by arranging the screen of QCIF size at the point 1 horizontally adjacent to the screen of QCIF size at the point 2. Thus, instep S203, the encoded video data of the n-th block line at the point 1 is read and output. In step S204, the encoded video data of the n-th block line at the point 2 is read and output.

Each block line is read by obtaining a read pointer indicating the header of the area from which the encoded video data of one screen in each buffer or repeat data unit is read from the synthesis list.

In step S205, the counter n is incremented, and it is determined in step S206 whether or not n is larger than 3 indicating the number of block lines in each QCIF screen. If it is not larger than the number of block lines, then the number of block lines, then the processes in steps S203 and S204 are repeated. By repeating the processes in steps S203 and S204 for the number (3) of block lines of QCIF screen, the encoded video data contained in each buffer or in the repeat data unit at the points 1 and 2 is alternately synthesized for each block line.

Then, in step S207, the counter n is set to 1 again. By referring to the synthesis screen combination list, the composite data at the lower half of the screen of CIF size is configured by arranging the screen of QCIF size at the point 3 horizontally adjacent to the screen of QCIF size at the point 4. Thus, in step S208, the encoded video data of the n-th block line at the point 3 is read and output. In step S209, the encoded video data of the n-th block line at the point 4 is read and output.

Each block line is read by obtaining a read pointer indicating the header of the area from which the encoded video data of one screen in each buffer or repeat data unit is read from the synthesis list.

In step S210, the counter n is incremented, and it is determined in step S211 whether or not n is larger than 3 indicating the number of block lines in each QCIF screen. If it is not larger than the number of block lines, then the number of block lines, then the processes in steps S208 and S209 are repeated. By repeating the processes in steps S208 and S209 for the number (3) of block lines of QCIF screen, the encoded video data contained in each buffer or in the repeat data unit at the points 3 and 4 is alternately synthesized for each block line.

Since the encoded video data output from the encoding unit is transmitted through the stream synthesis unit, it is preferable for optimization to store in advance the encoded video data in the buffer unit so as to easily read one block line.

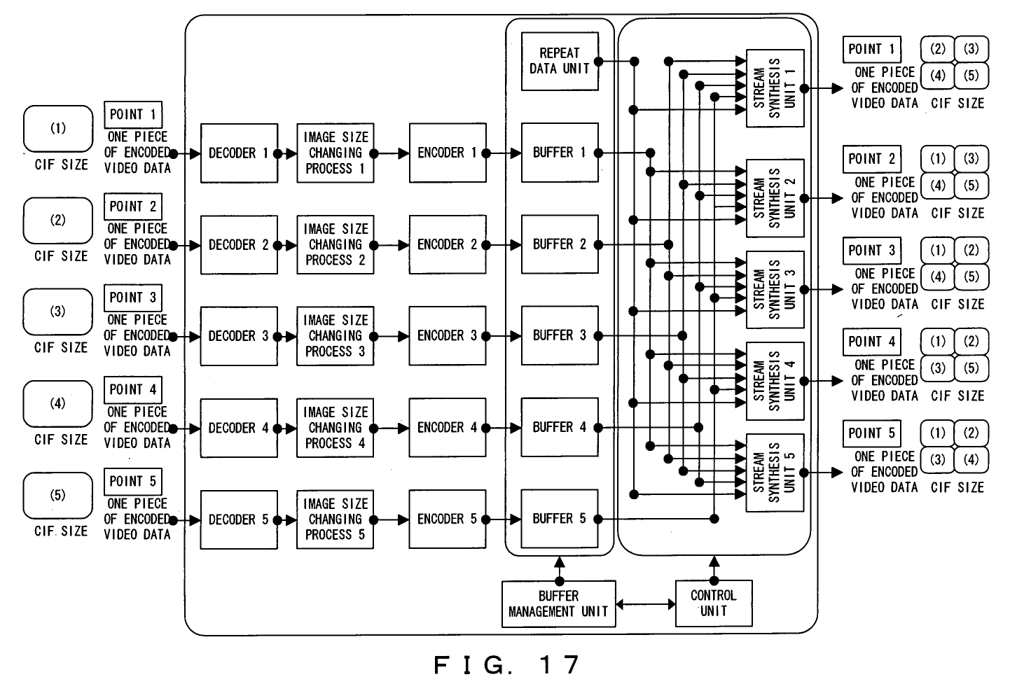

FIG. 17 shows the configuration of the encoded video data synthesis apparatus according to the first embodiment available for five points. As compared with the encoded video data synthesis apparatus shown in FIG. 12, the output point is increased from one point to five points, the stream synthesis unit is added for the difference, that is, four points.

In FIG. 17, the encoded video data of CIF size is transmitted from each of the points 1 through 5. The data is input to the decoders 1 through 5, and the decoding process is performed therein. The decoded data is reduced to ¼ from the CIF size to the QCIF size. Then, the stream synthesis units 1 through 5 at the later stage synthesize four ¼ reduced screens of QCIF size to obtain one screen in CIF size. The synthesized data of CIF size is transmitted to each point.

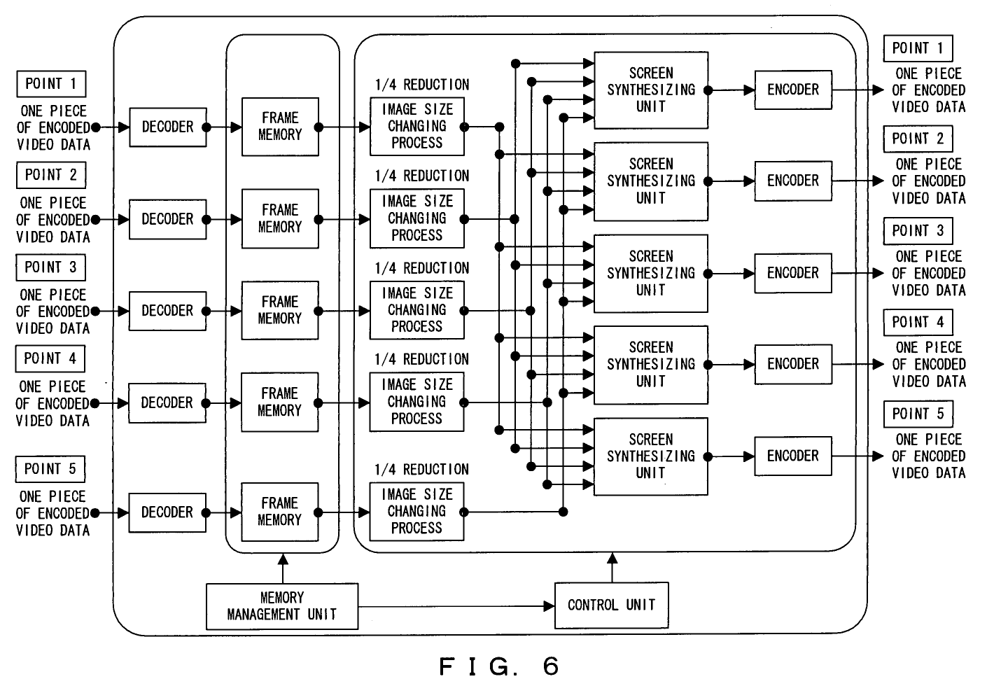

In the complete synthesis system according to the conventional technology, as shown in FIG. 6, when output for five points is carried out, each encoder has to perform the encoding process on the image of CIF size for five points even when the decoded data is reduced to ¼ from the CIF size to the QCIF size in the previous stage, thereby imposing a heavy process load. On the other hand, according to the present embodiment, the encoders 1 through 5 only have to perform the encoding process on the image of QCIF size for five points, thereby reducing the process load of each encoder to ¼. Thus, according to the first embodiment, the process load is reduced, and the function equivalent to the conventional complete synthesis system can be realized.

FIG. 17 shows the configuration in which the image transmitted from this side is not returned from the encoded video data synthesis apparatus as a composite image in each point, but other configurations can be applied. For example, the stream synthesis units 1 through 5 can select all data of the buffers 1 through 5 so that an instruction of the control unit can generate and transmit a composite image with the image transmitted from this side included.

In the above-mentioned first embodiment, a repeat data unit is provided to avoid the transmission delay of data from the encoded video data synthesis apparatus. With the above-mentioned configuration, it is not necessary for the control unit to know whether or not data of one or more frames is stored in all buffers. Therefore, the activation using the above-mentioned timer can be performed.

As an example of a variation according to the first embodiment, there can be a case in which no repeat data unit is used. In this case, a notification of the timing of reading data by presenting data of one frame for all buffers is provided from the buffer management unit to the control unit, thereby activating the control unit, reading encoded video data from each buffer, and performing stream synthesis on the encoded video data.

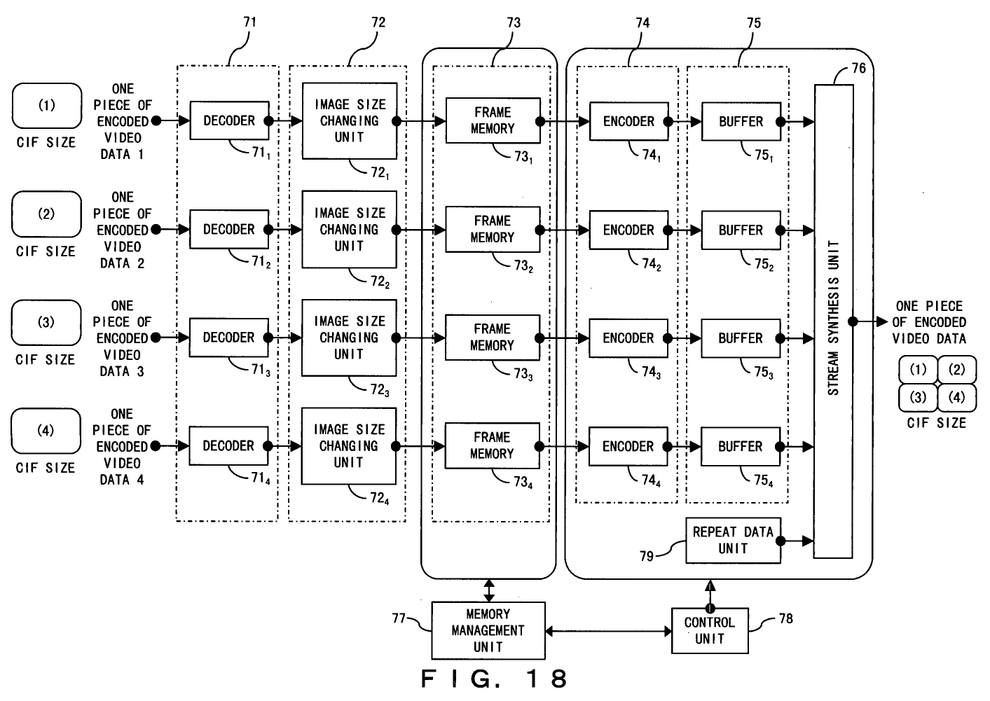

FIG. 18 is a block diagram showing the configuration of the encoded video data synthesis apparatus according to the second embodiment of the present invention. In the explanation of the second embodiment, the overlapping portion with the explanation according to the first embodiment is basically omitted.

The encoded video data synthesis apparatus shown in FIG. 18 synthesizes the image data from, for example, the TV conference terminals 51, 52, 53, and 54 shown in FIG. 11, and transmits the synthesized data to the TV conference terminal 55.

In FIG. 18, an encoded video data synthesis apparatus 70 comprises a decoding unit 71, an image size changing unit 72, a frame memory unit 73, an encoding unit 74, a buffer unit 75, a stream synthesis unit 76, a memory management unit 77, a control unit 78, and a repeat data unit 79.

The decoding unit 71 comprises decoders 71₁, 72₂, 71₃, and 71₄. The image size changing unit 72 comprises size changing processes 72₁, 72₂, 72₃, and 72₄. The frame memory unit 73 comprises frame memory 73₁, 73₂, 73₃, and 73₄. The encoding unit 74 comprises encoders 74₁, 74₂, 74₃, and 74₄. The buffer unit 75 comprises buffers 75₁, 75₂, 75₃, and 75₄.

In FIG. 18, for example, the encoded video data from the TV conference terminals 51 through 54 shown in FIG. 11 are inputted to each of the decoders 71₁, 72₂, 71₃, and 71₄ of the decoding unit 71. After performing the decoding process on the encoded video data, the data is expanded as necessary.

The image size changing unit 72 performs the image size changing process such as an enlarging process, a reducing process, etc. In the present embodiment, the image size changing unit 72 performs the process of reducing the image size of the received image data into ¼. That is, each of the size changing processes 72₁, 72₂, 72₃, and 72₄ reduces the image size of the image data decoded by each of the decoders 71₁, 72₂, 71₃, and 71₄ into ¼. When no size change is made to the received image size, the image size changing unit 72 can be omitted from the configuration of the encoded video data synthesis apparatus.

For example, when the encoded video data is compressed on each TV conference terminal side by the CIF (common intermediate format: 352 pixels×288 pixels) size, the data is decoded to the CIF size again through each decoder. The decoded image data is treated in the size changing process, thereby reducing the size into ¼, that is, the QCIF (176 pixels×144 pixels) size.

Then, each of the image data reduced into ¼ is temporarily input to the frame memory unit 73, and output to the encoding unit 74 at the next stage with a predetermined timing. After compressing the image data from the frame memory unit 73 as necessary, the encoding process is performed by the encoding unit 74 such that the encoded video data of the encoding result can be synthesized as is in the stream synthesis unit 76.

In the second embodiment, the frame memory unit 73 is provided immediately before the encoding unit 74 for performing the encoding process so that the frame memory unit 73 can temporarily store the image data. Therefore, the encoding process can be performed synchronously. Thus, unlike the first embodiment in which one type of image (I picture or P picture) is to be selected to be processed because the encoding process is asynchronously performed, the type of image to be used when encoding process is performed can be selected from among a plurality of types of image each time the encoding process is performed in the second embodiment. For example, an I picture or a P picture can be selected as the type of image to be used.

The control unit 78 controls a series of processes from the compressing process to the stream synthesis. The control unit 78 is activated by a timer not shown in the attached drawings at predetermined intervals. For example, when the encoded video data of 15 frames/second is generated, the cycle indicating a predetermined interval is 15 Hz.

The memory management unit 77 manages the frame memory management table indicating the storage status of the image data in the frame memory 73₁, 73₂, 73₃, and 73₄. The frame memory management table is rewritten in response to the input of the image data from the size changing processes 72₁, 72₂, 72₃, and 72₄ at the previous stage and a read instruction from the control unit 78.

The image data stored in each of the frame memory 73₁, 73₂, 73₃, and 73₄ is input to the encoders 74₁, 74₂, 74₃, and 74₄ at the next stage at an instruction from the control unit 78, and treated in the encoding process for easier stream synthesis at the subsequent stage, for example, protecting a vector against pointing to outside the screen in the MPEG 4 system, etc.

The buffers 75₁, 75₂, 75₃, and 75₄ store the encoded video data respectively encoded by the encoders 74₁, 74₂, 74₃, and 74₄. As described above, since the encoding processes are synchronously performed in the present embodiment, the buffers 75₁, 75₂, 75₃, and 75₄ are used as buffers holding at least one frame of encoded video data.

Thus, since the buffer unit according to the second embodiment does not store a plurality of frames as in the first embodiment, no buffer management is performed.

As described above, since the encoding processes are synchronously performed, the image data can be encoded as the I picture or the P picture in the second embodiment.

The repeat data unit 79 holds the repeat data indicating that the error from the previous data is 0. The repeat data can be used when the image data is encoded as a P picture.

That is, when the control unit 78 issues a read instruction, and when no new image data is stored in at least one frame memory in the frame memory unit 73, the control unit 78 uses repeat data in the repeat data unit as encoded video data for the buffer corresponding to the frame memory storing no new image data.

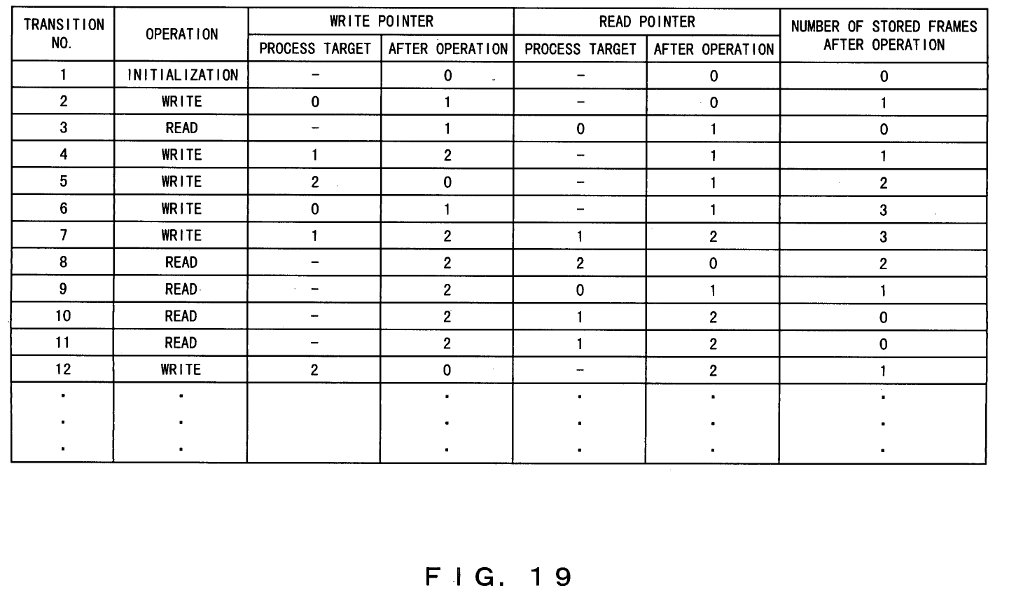

FIG. 19 shows an example of the status of the update in a time series of the frame memory management table corresponding to the frame memory in the frame memory unit 73, that is, an example of operation transition. FIG. 19 shows the data similar to the operation transition example of the buffer management table shown in FIG. 13, and aside the difference between the buffer and the memory, the operation contents are substantially the same. The differences are mainly described below.

In FIG. 19, the frame memory management table corresponding to the frame memory is configured as the ring memory whose maximum number of stored frames is 3. Therefore, a write pointer indicating the start of the data write area and a read pointer indicating the start of the data read area can be “0”, “1”, or “2”.

In the transition No. 11 shown in FIG. 19, in the status of the number of stored frames of “0”, the control unit issues a read instruction. For the read instruction issued when the number of stored frames is “0”, the repeat data of the repeat data unit is used as the data for the buffer corresponding to the frame memory storing no new data when image data is encoded as a P picture. On the other hand, when image data is encoded as an I picture for the read instruction issued when the number of stored frames is “0”, a read pointer is decremented, thereby reading again to the encoder at the later stage the image data read to the encoder at the later stage immediately before in the frame memory.

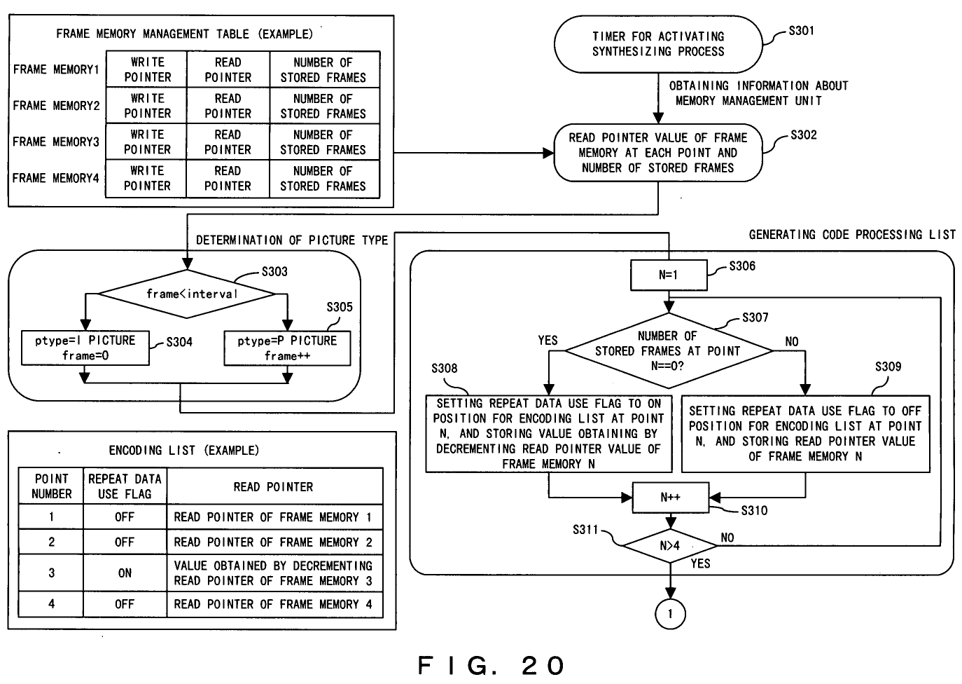

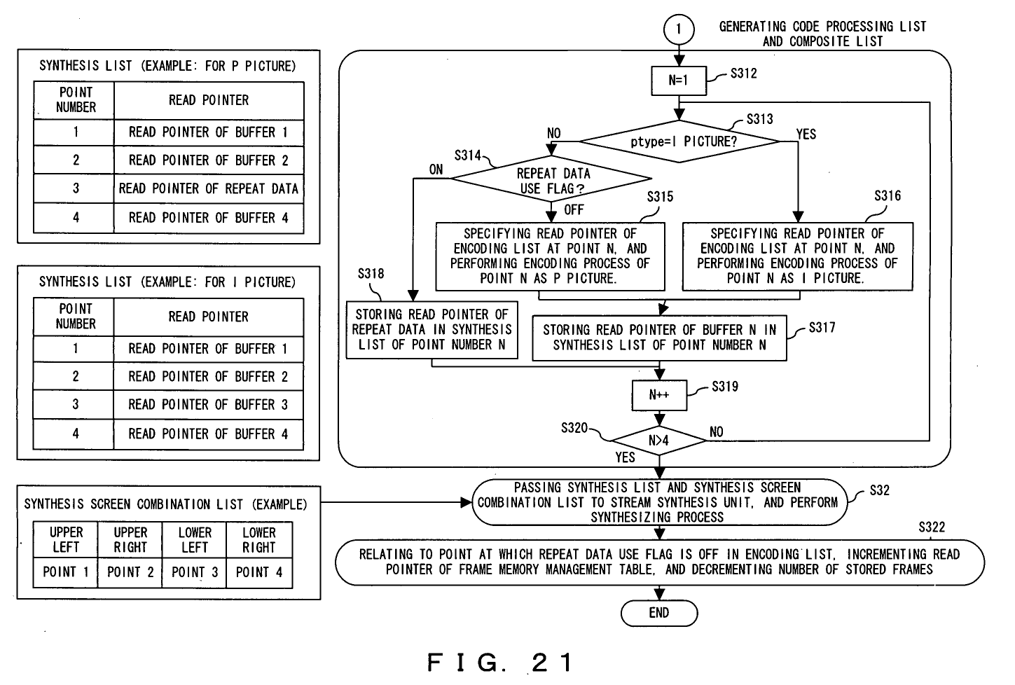

FIGS. 20 and 21 are flowcharts showing the process performed by the control unit. The control unit is activated by a timer at predetermined intervals, and performs the process shown in the flowchart described below each time it is activated. FIG. 20 is a flowchart of the first half portion, and FIG. 21 is a flowchart of the second half portion.

In FIG. 20, in step S301, the control unit is activated by a timer, and a series of processes performed by the control unit are started.

Then, in step S302, by referring to the frame memory management table corresponding to the point shown in FIG. 20, the read pointer value and the number of stored frames at each point are obtained.

In the second embodiment, every time the control unit is activated, an I picture or a P picture is specified to encode the image data stored in each frame memory. For example, the number of frames of P pictures to be inserted between an I picture and the next I picture is specified. The variable interval defined in the following table 1 is a threshold (for determining the number of frames of the P pictures to be inserted between I pictures) for determination of the frequency of the encoding performed only by the intra-frame coding, namely, performed as an I picture.

TABLE 1

| INTEREVAL | NUMBER OF FRAMES OF P PICTURES TO BE |
|---|---|
| VALUE | INSERTED BETWEEN I PICTURES |
| 0 | P PICTURE TO BE INSERTED IS 0 FRAME |
| | (ALL I PICTURES) |
| 1 | P PICTURE TO BE INSERTED IS 1 FRAME |
| | (I PICTURE AND P PICTURE ALTERNATELY) |
| . | |
| . | |
| . | |
| 14 | P PICTURE TO BE INSERTED IS 14 FRAMES |
| | (I PICTURE AT INTERVALS OF 1 FRAME IN 15 |
| | FRAMES) |
| . | |
| . | |
| . | |
| 29 | P PICTURE TO BE INSERTED IS 29 FRAMES |
| | (I PICTURE AT INTERVALS OF 1 FRAME IN 30 |
| | FRAMES) |
| . | |
| . | |
| . | |
| 255 | P PICTURE TO BE INSERTED IS 255 FRAMES |
| | (I PICTURE AT INTERVALS OF 1 FRAME IN 256 |
| | FRAMES) |
| 256 | ALL P PICTURES (NO I PICTURE) |

In the present flowchart, in the determination algorithm shown in steps S303, S304, and S305 in which the variable interval and the count variable frame are used, the number of frames of P pictures inserted between the I pictures is determined.

That is, the counter variable frame is a 8-bit variable without a sign, and the initial value is set to 0. Therefore, the frame can have the value from 0 to 255. When the value is incremented from frame=255, it is assumed that the frame is set to 0 (frame=0). The counter variable frame holds its value before and after the periodic activation of the control unit. And every time the control unit is activated, the counter variable frame is read from the storage unit (not shown) which stores the counter variable frame, and is referenced.

Described below is an example of the case in which variable interval=14. When the control unit is first activated, the counter variable frame is 0. Therefore, in the determination in step S303, the condition: frame<interval is satisfied. Therefore, control is passed to step S305. In step S305, the counter variable frame is incremented from “0” to “1”. In step S305, the variable ptype indicating whether encoding is performed as the I picture or as the P picture is set to the P picture. Thus, the corresponding image data is encoded as the P picture.

The above-mentioned process is performed each time the control unit is activated, and the counter variable frame is incremented each time. After inserting image data which is encoded as the P picture continuously 14 times, the counter variable frame becomes 14 (counter variable frame=14). And in the determination in step S303, the condition: frame<interval is not satisfied, and control is passed to step S304. In this step, the variable ptype is set to the I picture, and the counter variable frame is initialized to 0. That is, the variable ptype for determining the format of the encoding is set as the I picture so that the encoding can be performed such that the encoded data can be the I picture each time the value set for the counter variable frame matches the threshold defined by the variable interval.

By repeating the process in steps S303, S304, and S305 each time the control unit is activated, the encoding is periodically performed by inserting 14 P pictures among the I pictures in the case of the variable interval is set to 14 (variable interval=14). It is possible to set the value of variable interval to the value other than 14, and the process in this case is similarly performed.

In the determination flow in steps S303 through S305, after determining the encoding to be performed as the I picture or the P picture, the encoding list generating process is performed in the subsequent steps S306 through S311.

In the list generating process, first in step S306, the counter N is initialized to 1. The counter N indicates the number of the frame memory, or the number of the buffer for holding at least 1 frame of encoded video data corresponding to the frame memory. The frame memory or the buffer for at least one frame of encoded video data stores the image data or the encoded video data corresponding to either point. In the present flowchart, the image data and the encoded video data of the point number N are stored in each frame memory N and buffer N.

In step S307, it is determined whether or not the number of stored frames at the point N (frame memory N) is zero (0). If it is determined that the number of stored frames is 0 at the point N, then control is passed to step S308. In step S308, the repeat data use flag is set in the position “ON”, and the value obtained by decrementing the read pointer of the frame memory N obtained from the frame memory management table is stored as the read pointer corresponding to the frame memory N in the encoding list. Thus, it is possible to reuse the image data which is the newest in time in the encoded image data in the frame memory N. The above-mentioned repeat data use flag indicates that the repeat data of the repeat data unit is used when the encoding is performed as the P picture.

In step S307, when it is determined that the number of stored frames of the point (frame memory) N is not 0, control is passed to step S309. In step S309, the repeat data use flag is set in the OFF position, and the read pointer of the frame memory N obtained from the frame memory management table is stored as a read pointer corresponding to the point (frame memory) N in the encoding list.

In step S310, the counter N indicating the number of the frame memory is incremented. In step S311, it is determined whether or not the counter N is larger than the number of frame memory (4 in this example) to be processed. When the counter N does not exceed the number of frame memory to be processed, the generating process has not been completed on all frame memory to be processed. Therefore, control is returned to step S307, and the similar determination process is performed on the next frame memory.

As a result of a series of list generating processes, as shown in the attached drawings, a encoding list formed by the number of frame memory and the read pointer corresponding to the number is generated.

Then, in FIG. 21, in steps S312 through S320, the encoding process and the synthesis list generating process are performed.

In step S312, the counter N indicating the number of the frame memory or the buffer is set to 1. In step S313, the variable ptype set in steps S304 and S305 is referred to, and it is determined whether or not the value of the variable ptype matches the I picture.

In step S313, when the variable ptype matches the I picture, control is passed to step S316, and the read pointer corresponding to the point (frame memory) N in the encoding list is specified as a pointer to the header of the area storing image data to be encoded this time. Then, based on the specified read pointer and the format specified by the variable ptype, the I picture in this case, the encoding process on the point N is performed.

In step S313, when the variable ptype does not match the I picture, control is passed to step S314, and the value of the repeat data use flag is determined. If the repeat data use flag is OFF in step S314, control is passed to step S315, and the read pointer corresponding to the point (frame memory) N of the encoding list is specified as a pointer to the header of the area storing image data to be encoded this time. Then, based on the specified read pointer and the format specified by the variable ptype, the P picture in this case, the encoding process on the point N is performed.

In each of the encoders in the encoding unit, the data encoded in step S315 or S316 is stored in each of the corresponding buffers in the buffer unit at the subsequent stage. For example, the encoded video data encoded in the encoder N is stored in the buffer N.

In step S317, apart of the synthesis list referred to when the stream synthesis is performed is generated. That is, the read pointer of the encoded video data encoded in the encoder N and stored in the buffer N is stored as a read pointer corresponding to the point (buffer) N in the synthesis list.

On the other hand, in step S314, when the repeat data use flag is ON, the repeat data is used for the frame memory N to be processed, and control is passed to step S318 without activating the corresponding encoder in the subsequent stage. In step S318, the read pointer of the repeat data is stored as a read pointer corresponding to the point (buffer) N in the synthesis list.

In step S319 after the steps S317 and S318, the counter N is incremented. In step S320, it is determined whether or not the incremented counter N has exceeded the number of points (4 in this case) to be processed. If the counter N does not exceed the number of points to be processed, the synthesis list generating process has not been completed on all points (frame memory, buffer) to be processed. Therefore, control is returned to step S313, and the similar determining process is performed on the subsequent point (frame memory, buffer).

As a result of the synthesis list generating process, for example, the synthesis list (in the case of the P picture or the I picture) as shown in FIG. 15 is generated.

In the above-mentioned descriptions, a read instruction is issued to the frame memory 3 with the status of the number of stored frames set to 0. Therefore, as the read pointer corresponding to the buffer 3 in the synthesis list (in the case of the P picture), a read pointer of the repeat data is stored.

Then, in step S321, the stream synthesizing process is performed based on the synthesis list and the synthesis screen combination list shown in FIG. 21. For example, the processes are performed as shown in FIGS. 15 and 16.

Then, instep S322, relating to the point (buffer) where the repeat data use flag in the encoding list is OFF, the read pointer of the frame memory in the frame memory management table is incremented, and the number of stored frames is decremented, thereby updating the information in the frame memory management table.

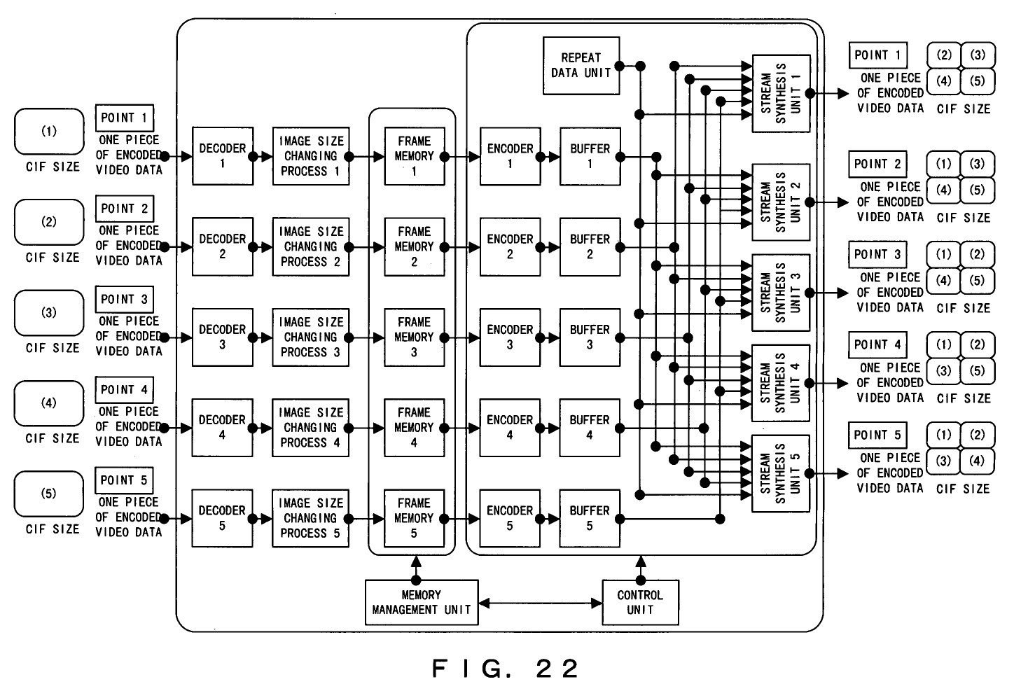

FIG. 22 shows the configuration of the encoded video data synthesis apparatus according to the second embodiment available for five points. As compared with the encoded video data synthesis apparatus shown in FIG. 18, the number of points to be output has increased from 1 to 5 points. Therefore, the stream synthesis unit is added for the additional 4 points which is the difference.

FIG. 22 shows the encoded video data of CIF size transmitted from each of the points 1 through 5. The data is input to the decoders 1 through 5, and the decoding process is performed therein. The image size changing processes 1 through 5 are performed on the data treated in the decoding process, thereby reducing the data into ¼ from the CIF size to the QCIF size. Then, the stream synthesis units 1 through 5 at the subsequent stage obtain one screen of CIF size by synthesizing the four screens of QCIF size. The synthesized data of the CIF size is transmitted to each point.

In the complete synthesis system as shown in FIG. 6, when output is made for similar five points, each encoder has to perform the encoding process on the image of CIF size for five points even when the decoded data is reduced to ¼ from the CIF size to the QCIF size in the previous stage, thereby having a heavy process load. On the other hand, according to the present embodiment, the encoders 1 through 5 only have to perform the encoding process on the image of QCIF size for five points, thereby reducing the process load of each encoder into ¼. Thus, according to the second embodiment, the process load is reduced, and the function equivalent to the conventional complete synthesis system can be realized.

FIG. 22 shows the configuration in which an image transmitted from this side in each point is not returned as a composite image from the encoded video data synthesis apparatus, and the other configuration can be applied. For example, a composite image can be generated and transmitted with the image transmitted from this side can be contained at an instruction of the control unit after allowing the stream synthesis units 1 through 5 to select all data of the buffers 1 through 5.

In the second embodiment described above, the transmission delay of data from the encoded video data synthesis apparatus has been avoided by providing a repeat data unit. With this configuration, it is not necessary for the control unit to know whether or not one or more frame of data is stored in all frame memory. Therefore, the activation by the above-mentioned timer can be performed.

It is possible not to provide a repeat data unit as an example of a variation of the second embodiment. In this case, the control unit is activated by a notification about the data read timing of presenting data of one frame for all frame memory, etc. from the memory management unit to the control unit, image data is read from each frame memory, the encoder encodes the image data, and then the stream synthesis unit performs the stream synthesis to the encoded video data of the encoding result.

1. An encoded video data synthesis apparatus, comprising:
a decoding unit having N, that is, two or more, decoders decoding input encoded video data;
an encoding unit having N encoders encoding image data from the decoding unit;
a buffer unit comprising N buffers capable of storing a predetermined number of frames of encoded video data as a process result of said encoding unit;
a buffer management unit managing a buffer management table indicating storage status of encoded video data in said buffer unit;
a stream synthesis unit performing a synthesizing process on the encoded video data of one frame from each buffer; and
a control unit issuing an instruction to said stream synthesis unit to perform a synthesizing process on one frame based on the buffer management table.

2. The apparatus according to claim 1, wherein
when all buffers of said buffer unit store at least one frame of encoded video data, said buffer management unit issues an activation notice to said control unit.

3. The apparatus according to claim 1, further comprising
a repeat data unit holding repeat data indicating that an error from previous data is zero, wherein
when there is no new encoded video data in at least one buffer in said buffer unit, said control unit uses repeat data in said repeat data unit as encoded video data for a buffer storing no new encoded video data.

4. The apparatus according to claim 3, wherein
said control unit is activated at predetermined time intervals.

5. The apparatus according to claim 1, further comprising
an image size changing unit performing a process of changing an image size on N pieces of decoded image data from said decoding unit, wherein
said encoding unit encodes N pieces of size-changed image data.

6. The apparatus according to claim 5, wherein
said image size changing unit reduces an image size.

7. An encoded video data synthesis apparatus, comprising:
a decoding unit having N, that is, two or more, decoders decoding input encoded video data;
a frame memory unit having N frame memory units capable of storing a predetermined number of pieces of image data from said decoding unit;
a memory management unit managing a frame memory management table indicating storage status of image data in said frame memory unit;
a encoding unit comprising N encoders encoding image data from said frame memory unit;
a buffer unit comprising N buffers capable of storing at least one frame of encoded video data as a process result of said encoding unit;
a stream synthesis unit performing a synthesizing process on the encoded video data of one frame from each of said buffers; and
a control unit controlling said encoding unit and buffer unit according to the frame memory management table, and issuing an instruction to perform a synthesizing process on the one frame to said stream synthesis unit.

8. The apparatus according to claim 7, wherein
when all frame memory of said frame memory unit store at least one frame of image data, said memory management unit issues an activation notice to said control unit.

9. The apparatus according to claim 7, wherein
said control unit comprises a encoding format determination unit for determining whether a process of encoding one frame of data by intra-frame coding only is to be performed or a process of encoding one frame of data using difference data from a reference frame in addition to intra-frame coding, and issues an instruction to each of said encoders to encode each piece of image data from said frame memory unit based on a determined encoding format.

10. The apparatus according to claim 9, wherein
said control unit is activated at predetermined time intervals; and further comprising
an activation frequency storage unit holding a value of a counter variable which reflects an activation frequency of said control unit, wherein
said encoding format determination unit determines based on the counter variable whether data is to be encoded by each encoder by intra-frame coding only or data is to be encoded using difference data from a reference frame in addition to intra-frame coding.

11. The apparatus according to claim 9, further comprising
a repeat data unit holding repeat data indicating that an error from previous data is zero, wherein
when said encoding format determination unit determines to encode one frame of data using difference data from a reference frame in addition to intra-frame coding, and when new image data is not contained in at least one frame memory in said frame memory unit, said control unit uses repeat data of said repeat data unit as data for the buffer corresponding to the frame memory storing no new image data.

12. The apparatus according to claim 11, wherein
said control unit is activated at predetermined time intervals.

13. The apparatus according to claim 7, further comprising
an image size changing unit performing a process of changing an image size on N pieces of decoded image data from said decoding unit, wherein
said frame memory unit stores N pieces of size-changed image data.

14. The apparatus according to claim 13, wherein
said image size changing unit reduces an image size.
